(19) United States
(12) Patent Application Publication
(10) Pub. No.: US 2021/0037854 A1
(43) Pub. Date: Feb. 11, 2021

(54) EGGS RICH IN NUTRIENTS OF ALPHA-LINOLENIC ACID AND DHA, BREEDING METHOD OF LAYING HENS, AND FEED ADDITIVE

(71) Applicants: XINGSHI TAO, WuHan (CN); GuoPan Gao, Xinxiang City (CN); YuLing Liu, Xinxiang City (CN)

(72) Inventors: XINGSHI TAO, WuHan (CN); GuoPan Gao, Xinxiang City (CN); YuLing Liu, Xinxiang City (CN)

(21) Appl. No.: 16/863,474

(22) Filed: Apr. 30, 2020

(30) Foreign Application Priority Data
Aug. 5, 2019 (CN) 201910715915.3

(51) Int. Cl. A23K 10/30; A23K 50/75; A23L 15/00

(52) U.S. Cl. CPC A23K 10/30; A23V 2002/00; A23L 15/00; A23K 50/75

(57) ABSTRACT

An egg rich in nutrients of α-linolenic acid and DHA, a breeding method of laying hens and a feed additive are provided. Laying hens are fed with a feed additive rich in α-linolenic acid, after the feed additive are digested and absorbed by the laying hens, a part of the α-linolenic acid is enriched in the egg yolk, and another part of the α-linolenic acid is used as a precursor which is metabolized to be DHA by laying hen's biochemical process and thereby partially enriched in the egg yolk. Therefore, the contents of these two nutrients in eggs are greatly increased and reach their respective healthy supply levels, consumers can obtain stable and sufficient nutrition supply from the eggs. The invention can effectively solve a current situation of too low α-linolenic acid and DHA contents in ordinary eggs while maintaining the nature of eggs as a consumer product.

### FIELD OF THE INVENTION

The invention relates to a technical field of eggs production, and more particularly to an egg rich in nutrients of alpha-linolenic acid and docosahexaenoic acid (DHA), a breeding method of laying hens, and a feed additive.

### BACKGROUND OF THE INVENTION

There are two isomers of linolenic acid, α-linolenic (alpha-linolenic) acid (all cis-9,12,15-octadecadienoic acid, belongs to the ω-3 series, sometimes referred to as linolenic acid) and γ-linolenic acid (all cis-6,9,12-octadecadienoic acid, belongs to ω-6 series). Linseed, perilla seed and eucommia seed are known as the highest α-linolenic acid plant seeds, and evening primrose seeds are the highest γ-linolenic acid herb seeds.

α-linolenic acid and its derivatives provide energy for human growth and muscle movement, which is only part of its function, and more importantly, as a structural substance and metabolic regulating substance, it exerts regulatory functions of structural functions and physiological activities. Once the human body lacks α-linolenic acid, it will cause disorders of lipid metabolism in the body, leading to symptoms such as decreased immunity, forgetfulness, fatigue, vision loss, and atherosclerosis. In particular, if infants and young children and adolescents lack α-linolenic acid, they will seriously affect their normal physical and intellectual development. This has been confirmed by scientists at home and abroad and recognized by the world's nutritional community. In addition, the lack of α-linolenic acid can also cause vitamins, minerals, proteins and other nutrients not to be effectively absorbed and utilized, resulting in nutrient loss.

A statement issued jointly by the World Health Organization (WHO) and the Food and Agriculture Organization of the United Nations (FAO) in 1993 stated that, given the importance of α-linolenic acid and the general lack of humanity, it was decided to specifically promote α-linolenic acid worldwide. The World Health Organization (WHO), the Ministry of Health of the People's Republic of China, and the Chinese Nutrition Association have agreed in 2000 that α-linolenic acid is the only essential fatty acid in the ω-3 line. The World Health Organization's recommended daily intake of α-linolenic acid for adults is 1250 mg; the average per capita intake in China is less than half of the recommended amount.

α-linolenic acid in food is absorbed by the intestine, stored in the liver, and transported to various parts of the body via the blood, directly becoming a structural substance of the cell membrane or participating in metabolic reactions. As the parent of polyunsaturated fatty acids, α-linolenic acid can also be metabolized to produce a variety of highly active substances under the action of carbon chain elongating enzymes and dehydrogenases, including EPA (all cis-5,8,11,14,17-eicosapentaenoic acid, belongs to the ω-3 series). EPA is a precursor of three series of prostaglandins. It produces PGE5, PG13, LTB5, TXA3 and other active substances under the action of lipoxygenase and cyclooxygenase, and regulates many biochemical reactions in the body. EPA is also a precursor substance that is metabolized into DHA (all cis-4,7,10,13,16,19-docosahexaenoic acid in the human body, belonging to the ω-series).

DHA is an unsaturated fatty acid that is very important to the human body. It is one of the main nutrients for the growth and maintenance of nervous system cells. It is an important component of the brain and retina; the content in the human cerebral cortex (brain gray matter) is as high as 20%, and it is the largest in the retina, accounting for about 50%. Therefore, it is important to maintain the health of the fetus, infants, and the elderly in the peak of intellectual and visual development. The World Health Organization (WHO)'s recommendations for the consumption of DHA are as follows:

| Population classification | Recommended daily DHA intake |
|---|---|
| Infant | minimum intake: 20 mg/kg body weight |
| Toddler | minimum intake: 100 mg |
| Pregnant women | minimum intake: 300 mg |
| Healthy people | minimum intake: 220 mg |

DHA is also a very scarce resource. It is still a common phenomenon not to get the necessary supply, whether rich or poor, or at home or abroad. There are two sources of DHA in the human body: 1. It is synthesized in vivo, but due to insufficient precursor material α-linolenic acid, the biochemical process is complicated, and the ability to synthesize DHA is very weak. 2. Dietary intake, because of the lack of natural resources, the amount of DHA in daily food is also very small. For those who particularly need DHA for physical development and health maintenance, supplementation from the diet is necessary.

The diet of the Chinese population is generally deficient in α-linolenic acid and the daily intake is less than the World Health Organization's recommended amount-half of 1.25 grams per person per day. At present, the domestic awareness of α-linolenic acid is not enough, and the consumption of α-linolenic acid is not universal. It is indeed necessary to supplement α-linolenic acid in an appropriate amount according to the specific conditions of consumers.

The period when a person can get a sufficient supply of α-linolenic acid and DHA throughout his or her life is also the period when the body and nervous system develop the fastest fetus and the period when the baby is breastfed. The content of α-linolenic acid in maternal colostrum is about 47 mg/100 g of milk, and the content of DHA is about 15 mg/100 g of milk. Based on 600-800 ml of breast milk consumed daily, the daily intake of α-linolenic acid is 282-376 mg, and the DHA nutrient is 90-120 mg. For newborn babies weighing less than 5 kg, the intensity of this supply is amazing. Studies have found that breastfeeding infants have significantly higher cognitive development scores than artificially fed infants, which also proves that α-linolenic acid and DHA are important for infant brain development.

Eggs are one of the very few popular foods that contain both α-linolenic acid and DHA. However, the content of these two nutrients is far from the requirements of human health supply.

### SUMMARY OF THE INVENTION

In order to solve the above-mentioned nutrition problems existing in ordinary eggs, the present invention provides an egg rich in nutrients of α-linolenic acid and DHA, a method for breeding laying hens and a feed additive. The content of α-linolenic acid is no less than 400 milligrams per 100 grams of the egg, and the content of DHA is no less than 200 milligrams per 100 grams of the egg.

The technical scheme adopted by the present invention is:

an egg rich in nutrients of α-linolenic acid and DHA, the content of the α-linolenic acid no less than 0.4 grams per 100 grams of the egg, and the content of the DHA no less than 0.2 grams per 100 grams of the egg.

Moreover, a feed additive for breeding a laying hen capable of producing an egg rich in nutrients of alpha-linolenic (α-linolenic) acid and docosahexaenoic acid (DHA) is provided. The feed additive includes one selected from a group consisting of a linseed, a perilla seed, an eucommia seed, a linseed oil, a perilla seed oil, an eucommia seed oil, and mixtures thereof.

In an embodiment, a mass percentage of the linseed of the feed additive in a feed with the feed additive is 5.5˜7, a mass percentage of the perilla seed of the feed additive in a feed with the feed additive is 3.8˜4.8, a mass percentage of the eucommia seed of the feed additive in a feed with the feed additive is 5.5˜7, a mass percentage of the linseed oil of the feed additive in a feed with the feed additive is 2˜2.5, a mass percentage of the perilla seed oil of the feed additive in a feed with the feed additive is 1.5˜1.9, and/or a mass percentage of the eucommia seed oil of the feed additive in a feed with the feed additive is 1.5˜1.9.

In order to achieve the production of the egg rich in nutrients of α-linolenic acid and DHA, the feed for hens preferably is a compound feed made by combining the feed additive rich in the nutrient of α-linolenic acid and a conventional feed (or called as raw feed). In order to ensure the comprehensive quality of eggs and the realization of content requirements of the nutrients of α-linolenic acid and DHA, a ratio of the feed additive to the raw feed in the compound feed preferably ensures that a content of the nutrient of α-linolenic acid in daily diet per hen is no less than 1.5 grams.

In addition, a method for breeding laying hens capable of producing eggs rich in nutrients α-linolenic acid and DHA is provided. The method includes: feeding laying hens each aged greater than 125 days by using a feed with a feed additive including one selected from the group consisting of a linseed, a perilla seed, a linseed oil, a perilla seed oil, and mixtures thereof; and starting to collect eggs on an 8th day after the feeding and continuing in a whole laying period of the laying hens.

The beneficial effects of the present invention are:

The present invention adopts a feed additive rich in α-linolenic acid to feed laying hens, and after digestion and absorption of the laying hens, a part of α-linolenic acid is enriched in the yolk, and a part of α-linolenic acid is used as a precursor. It is metabolized to DHA by laying hen's biochemical process, and partially enriched in egg yolk; as a result, the contents of these two nutrients in eggs have been greatly increased, reaching their respective healthy supply levels; provide consumers with a stable and adequate nutrition supply. The invention can effectively solve the current situation of too low α-linolenic acid and DHA content in ordinary eggs, and maintain the natural color of eggs as a consumer product. Another function of the present invention is to provide an efficient, safe, and economic way to obtain DHA by using herb seeds or vegetable oils as raw materials. From then on, DHA gets rid of the scarcity of resources and high prices and enters the category of mass food. Polyunsaturated fatty acid DHA is very easy to be oxidized, stored in eggs and isolated from the air, and protected; phospholipids in eggs help digestion and absorption of DHA.

### DETAILED DESCRIPTION OF EMBODIMENTS

The present invention is described in detail below with reference to specific embodiments. In the following embodiments, 1 g is represented by 1 part by weight.

### Embodiment 1

This embodiment provides a feed additive for cultivating eggs rich in α-linolenic acid and DHA, the feed additive is a mixture of linseed, perilla seed, linseed oil, and perilla seed oil in a mass ratio of 5.5:3.8:2:1.5. The content of α-linolenic acid in the feed additive is 30.44%, and the daily dosage of the feed additive is 5 g, that is, the daily dosage of α-linolenic acid is 1.522 g.

Feed Ingredients Include:

40 parts by weight of corn meal, 25 parts by weight of soybean meal, 2 parts by weight of fish meal, 5 parts by weight of bone meal, 5 parts by weight of cottonseed oil, 3 parts by weight of calcium additive, 2 parts by weight of a multivitamin, 0.1 parts by weight of a trace element, 0.005 parts by weight of a probiotic, and 5 parts by weight of a compound feed additive.

The calcium element additive is a mixture composed of calcium carbonate, calcium lactate and calcium bicarbonate according to a mass ratio of 2:1:1; the multivitamin is a mixture of vitamin A, vitamin D, vitamin E, vitamin K, and vitamin B12 according to a mass ratio of 1:2:1:2:1; the trace element is a mixture composed of ferrous sulfate, zinc sulfate, and sodium selenite according to a mass ratio of 1:1:1; the probiotic bacteria are a mixture of dry bacteria powders of three strains of Lactobacillus, Actinomycete, and Bifidobacterium according to a mass ratio of 1:1:1.

Further, a method for preparing the feed is provided, which includes the following steps:

(1) taking corn meal, soybean meal, fish meal, bone meal, calcium additive, multivitamins, trace elements, and compound feed additives according to the above weight, mixing them thoroughly to pulverize into fine powder; adding hot water which accounts for 50% of the mass of the mixed fine powder to the mixed fine powder and stirring well to obtain a wet material;

(2) taking the probiotics according to the above weight, adding warm water accounting for 1 times the mass of the probiotics, and stirring uniformly to obtain a probiotic solution;

(3) mixing the wet material in step (1) with the probiotic solution in step (2), adding the fat components in cottonseed oil and feed additives, and granulating and drying to obtain the feed.

The feed is used to feed the laying hens after 125 days of age, the nutritional eggs are extracted on the 8th day, and the whole process of the laying period is continued.

90 g of standard feed was fed to the laying hen at 1 kg per day.

After testing, the content of α-linolenic acid in the harvested eggs was 0.42 grams per 100 grams of the eggs, and the content of DHA was 0.21 grams per 100 grams of the eggs.

### Embodiment 2

This embodiment provides a flaxseed rich in α-linolenic acid as a feed additive for laying hens, with a daily dosage of 8.2 g. The content of α-linolenic acid in the feed additive was 1.53 g.

Feed Ingredients Include:

50 parts by weight of corn meal, 15 parts by weight of soybean meal, 8 parts by weight of fish meal, 2 parts by weight of bone meal, 15 parts by weight of cottonseed oil, 1 part by weight of calcium additive, 5 parts by weight of multivitamin, 0.02 parts by weight of trace elements, 0.01 parts by weight of probiotics, and 8.2 parts by weight of feed additive flaxseed.

The calcium element additive is a mixture composed of calcium carbonate, calcium lactate and calcium bicarbonate according to a mass ratio of 3:2:2; the multivitamin is a mixture of vitamin A, vitamin D, vitamin E, vitamin K, and vitamin B12 according to a mass ratio of 1:2:1:2:1; the trace element is a mixture composed of ferrous sulfate, zinc sulfate, and sodium selenite according to a mass ratio of 2:1:2; the probiotic bacteria are a mixture of dry bacteria powders of three strains of lactobacillus, actinomycete, and bifidobacteria according to a mass ratio of 1:2:2.

Further, a method for preparing the feed is provided, which includes the following steps:

(1) taking corn meal, soybean meal, fish meal, bone meal, calcium additive, multivitamins, trace elements, and compound feed additives according to the above weight, mixing them thoroughly to pulverize into fine powder; adding hot water which accounts for 60% of the mass of the mixed fine powder to the mixed fine powder and stirring well to obtain a wet material;

(2) taking probiotics according to the above weight, adding warm water accounting for twice the mass of the probiotics and stirring uniformly to obtain a probiotic solution;

(3) mixing the wet material in step (1) with the probiotic solution in step (2), adding cottonseed oil, and granulating and drying to obtain the feed.

The feed is used to feed the laying hens after 125 days of age, the nutritional eggs are extracted on the 8th day, and the whole process of the laying period is continued.

90 g of standard feed was fed to the laying hen at 1 kg per day.

After testing, the content of α-linolenic acid in the harvested eggs was 0.45 grams per 100 grams of the eggs, and the content of DHA was 0.21 grams per 100 grams of the eggs.

### Embodiment 3

This embodiment provides a compound feed additive for raising eggs rich in α-linolenic acid and DHA nutrients, which is composed of linseed, perilla seed, linseed oil, and perilla seed oil in a mass ratio of 7:4.8:2.5:1.9. The content of α-linolenic acid in the feed additive is 31.06%, and the daily amount of the feed additive is 5 g, that is, the daily amount of α-linolenic acid is 1.55 g.

The raw material components include:

45 parts by weight of corn meal, 20 parts by weight of soybean meal, 5 parts by weight of fish meal, 3.5 parts by weight of bone meal, 10 parts by weight of cottonseed oil, 2 parts by weight of calcium additive, 3.5 parts by weight of multivitamins, 0.06 parts by weight of trace elements, 0.075 parts by weight of probiotics, and 5 parts by weight of compound feed additives.

The calcium element additive is a mixture composed of calcium carbonate, calcium lactate and calcium bicarbonate according to a mass ratio of 2.5:1.5:1.5:1.5; the multivitamin is a mixture of vitamin A, vitamin D, vitamin E, vitamin K, and vitamin B12 according to the mass ratio 1:2:1:2:1; the trace element is a mixture composed of ferrous sulfate, zinc sulfate, and sodium selenite according to a mass ratio of 1:1:1; the probiotic bacteria are a mixture of dry bacteria powders of three strains of Lactobacillus, Actinomycete, and Bifidobacterium according to a mass ratio of 1:1.5:1.5.

Further, a method for preparing the feed is provided, which includes the following steps:

(1) taking corn meal, soybean meal, fish meal, bone meal, calcium additive, multivitamins, trace elements, and compound feed additives according to the above weight, mixing them thoroughly to pulverize into fine powder; adding hot water which accounts for 55% of the mass of the mixed fine powder to the mixed fine powder and stirring well to obtain a wet material;

(2) taking probiotics according to the above weight, adding warm water accounting for 1.5 times the mass of the probiotics, and stirring them to obtain a probiotic solution;

(3) mixing the wet material in step (1) with the probiotic solution in step (2), adding the fat components in cottonseed oil and feed additives, and granulating and drying to obtain the feed.

The feed is used to feed the laying hens after 125 days of age, the nutritional eggs are extracted on the 8th day, and the whole process of the laying period is continued.

95 g of standard feed was fed to the laying hen at 1 kg per day.

After testing, the content of α-linolenic acid in the harvested eggs was 0.51 grams per 100 grams of the eggs, and the content of DHA was 0.23 grams per 100 grams of the eggs.

### Embodiment 4

This embodiment provides a perilla seed rich in α-linolenic acid as a feed additive for laying hens, with a daily dosage of 6.8 g. The content of α-linolenic acid in the feed additive was 1.64 g.

Feed Ingredients Include:

42 parts by weight of corn meal, 22 parts by weight of soybean meal, 4 parts by weight of fish meal, 4 parts by weight of bone meal, 8 parts by weight of cottonseed oil, 2.5 parts by weight of calcium additive, 4 parts by weight of multivitamin, 0.08 parts by weight of trace elements, 0.006 parts by weight of probiotics, and 6.8 parts by weight of feed additive.

The calcium element additive is a mixture composed of calcium carbonate, calcium lactate and calcium bicarbonate in a mass ratio of 2.2:1.8:1.2; the multivitamin is a mixture of vitamin A, vitamin D, vitamin E, vitamin K, and vitamin B12 according to a mass ratio of 1:2:1:2:1; the trace elements are a mixture consisting of ferrous sulfate, zinc sulfate, and sodium selenite in a mass ratio of 1.2:1.8:1.2; the probiotic bacteria are a mixture of dry bacteria powders of three strains of Lactobacillus, Actinomycete, and Bifidobacterium according to a mass ratio of 1:1.2:1.8.

Further, a method for preparing the feed is provided, which includes the following steps:

(1) taking corn meal, soybean meal, fish meal, bone meal, calcium additive, multivitamins, trace elements, and compound feed additives according to the above weight, mixing them thoroughly to pulverize into fine powder; adding hot water which accounts for 52% of the mass of the mixed fine powder to the mixed fine powder and stirring well to obtain a wet material;

(2) taking the probiotics according to the above weight, adding warm water accounting for 1-2 times the mass of the probiotics, and stirring uniformly to obtain a probiotic solution;

(3) mixing the wet material in step (1) with the probiotic solution in step (2), adding the cottonseed oil, and granulating and drying to obtain the feed.

The feed is used to feed the laying hens after 125 days of age, the nutritional eggs are extracted on the 8th day, and the whole process of the laying period is continued.

90 g of standard feed was fed to the laying hen at 1 kg per day.

After testing, the content of α-linolenic acid in the harvested eggs was 0.55 grams per 100 grams of the eggs, and the content of DHA was 0.21 grams per 100 grams of the eggs.

### Embodiment 5

This embodiment provides a linseed oil rich in α-linolenic acid as a feed additive for nutritional eggs, and the daily dosage is 3 g. The content of α-linolenic acid in the α-linolenic acid-rich linseed oil was 1.53 g.

Feed Ingredients Include:

48 parts by weight of corn meal, 16 parts by weight of soybean meal, 6 parts by weight of fish meal, 3 parts by weight of bone meal, 12 parts by weight of cottonseed oil, 1.2 parts by weight of calcium additive, 4 parts by weight of multivitamins, 0.03 parts by weight of trace elements, 0.008 parts by weight of probiotics, and 3 parts by weight of feed additives.

The calcium element additive is a mixture composed of calcium carbonate, calcium lactate and calcium bicarbonate according to a mass ratio of 2.8:1:1.8; the multivitamin is a mixture of vitamin A, vitamin D, vitamin E, vitamin K, and vitamin B12 according to a mass ratio of 1:2:1:2:1; the trace element is a mixture composed of ferrous sulfate, zinc sulfate, and sodium selenite according to a mass ratio of 2:1:2; the probiotics are a mixture of dry bacteria powders of three strains of Lactobacillus, Actinomycete, and Bifidobacterium according to a mass ratio of 1:2:1.

Further, a method for preparing the feed is provided, which includes the following steps:

(1) taking corn meal, soybean meal, fish meal, bone meal, calcium additive, multivitamins, trace elements, and compound feed additives according to the above weight, mixing them thoroughly to pulverize into fine powder; adding hot water which accounts for 58% of the mass of the mixed fine powder to the mixed fine powder and stirring well to obtain a wet material;

(2) taking the probiotics according to the above weight, adding warm water accounting for 1.8 times the mass of the probiotics, and stirring uniformly to obtain a probiotic solution;

(3) mixing the wet material in step (1) with the probiotic solution in step (2), adding the fat components in cottonseed oil and feed additives, and granulating and drying to obtain the feed.

The feed is used to feed the laying hens after 125 days of age, the nutritional eggs are extracted on the 8th day, and the whole process of the laying period is continued.

90 g of standard feed was fed to the laying hen at 1 kg per day.

After testing, the content of α-linolenic acid in the harvested eggs was 0.45 grams per 100 grams of the eggs, and the content of DHA was 0.21 grams per 100 grams of the eggs.

The present invention is not limited to the above-mentioned preferred embodiments, and anyone can derive other various forms of products under the inspiration of the present invention. However, regardless of any changes in its shape or structure, any technical solution that is the same as or similar to the present application falls within the protection scope of the present invention.

What is claimed is:

1. An egg rich in nutrients of alpha-linolenic (α-linolenic) acid and docosahexaenoic acid (DHA), comprising a content of the α-linolenic acid no less than 0.4 grams per 100 grams of the egg, and a content of the DHA no less than 0.2 grams per 100 grams of the egg.

2. The egg rich in nutrients of α-linolenic acid and DHA according to claim 1, wherein the content of the α-linolenic acid is 0.42-0.55 grams per 100 grams of the egg, and the content of the DHA is 0.21-0.3 grams per 100 grams of the egg.

3. A feed additive for breeding a laying hen capable of producing an egg rich in nutrients of alpha-linolenic (α-linolenic) acid and docosahexaenoic acid (DHA), wherein the feed additive comprises one selected from a group consisting of a linseed, a perilla seed, an eucommia seed, a linseed oil, a perilla seed oil, an eucommia seed oil, and mixtures thereof.

4. The feed additive for breeding a laying hen capable of producing an egg rich in nutrients of α-linolenic acid and DHA according to claim 3, wherein a mass percentage of the linseed of the feed additive in a feed with the feed additive is 5.5˜7, a mass percentage of the perilla seed of the feed additive in a feed with the feed additive is 3.8˜4.8, a mass percentage of the eucommia seed of the feed additive in a feed with the feed additive is 5.5˜7, a mass percentage of the linseed oil of the feed additive in a feed with the feed additive is 2˜2.5, a mass percentage of the perilla seed oil of the feed additive in a feed with the feed additive is 1.5˜1.9, and/or a mass percentage of the eucommia seed oil of the feed additive in a feed with the feed additive is 1.5˜1.9.

5. The feed additive for breeding a laying hen capable of producing an egg rich in nutrients of α-linolenic acid and DHA according to claim 3, wherein the feed additive is applied for a compound feed, the compound feed is made by a raw feed and the feed additive, and a ratio of the feed additive to the raw feed in the compound feed meets that a content of the nutrient of α-linolenic in daily diet of one hen is no less than 1.5 grams.

6. A method for breeding laying hens capable of producing eggs rich in nutrients α-linolenic acid and DHA, comprising:
feeding laying hens each aged greater than 125 days by using a feed with the feed additive according to claim 3, starting to collect eggs on an 8th day after the feeding and continuing in a whole laying period of the laying hens.

7. The method for breeding laying hens capable of producing eggs rich in nutrients of α-linolenic acid and DHA according to claim 6, wherein feeding laying hens each aged greater than 125 days by using a feed with the feed additive comprises:
feeding 90-100 grams of the feed per day as per each one kilogram (1 kg) of the laying hens.
